(19) United States
(12) Patent Application Publication
(10) Pub. No.: US 2022/0325094 A1
(43) Pub. Date: Oct. 13, 2022

(54) RESIN COMPOSITION

(71) Applicant: KURARAY CO., LTD., Kurashiki-shi (JP)

(72) Inventor: Yasushi SENDA, Kamisu-shi (JP)

(73) Assignee: KURARAY CO., LTD., Kurashiki-shi (JP)

(21) Appl. No.: 17/447,598

(22) Filed: Sep. 14, 2021

(30) Foreign Application Priority Data
Apr. 5, 2021 (JP) 2021-064283

(51) Int. Cl. C08L 53/02; C08L 23/12; C08L 91/00

(52) U.S. Cl. CPC C08L 53/02; C08L 23/12; C08L 91/00

(57) ABSTRACT

A resin composition including a component (x) that is a hydrogenate (X) of a block copolymer having a polymer block (A-1) containing a structural unit derived from an aromatic vinyl compound and a polymer block (B-1) containing a structural unit derived from a conjugated diene compound; and a component (y) that is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, wherein the resin composition satisfies the following requirements [1] to [3];
[1] a glass transition temperature of the component (x) is −10° C. or higher;
[2] a glass transition temperature of the component (y) is lower than −10° C.; and
[3] a ratio Mx/My of a mass Mx of the component (x) to a mass My of the component (y) in the resin composition is 1/99 to 99/1.

### CROSS-REFERENCE TO RELATED APPLICATIONS

The present application is a continuation application of Japanese Patent Application No. 2021-064283, filed Apr. 5, 2021. The content of the application is incorporated herein by reference in their entirety.

### TECHNICAL FIELD

The present invention relates to a resin composition.

### BACKGROUND ART

As a thermoplastic elastomer having vibration resistance or soundproofing properties, block copolymers including a polymer block (A) composed of a structural unit derived from an aromatic vinyl compound and a polymer block (B) composed of a structural unit derived from a conjugated diene compound are known.

For example, PTL 1 describes a thermally expandable material for damping acoustic vibrations in vehicles, including two kinds of thermoplastic elastomers that are a styrenic copolymer, the glass transition temperatures of which differ from each other by at least 10° C. It is described that by using the two kinds of thermoplastic elastomers having a glass transition temperature different from each other, the loss factor may be made higher than the predetermined value in a broad temperature range as compared with use of a single kind of thermoplastic elastomer.

### CITATION LIST

### Patent Literature

PTL 1: JP 2010-539304 A

### SUMMARY OF INVENTION

### Technical Problem

In recent years, resin compositions capable of exhibiting higher performances for various applications are required, and the aforementioned resin composition including block copolymers is demanded to be more improved, too. Specifically, a resin composition exhibiting a high tan δ intensity in a broader temperature range is required.

PTL 1 describes that a hydrogenate may be used as the thermoplastic elastomer. However, it is actually difficult to produce a hydrogenate having a high glass temperature so as to conform to the aforementioned thermoplastic elastomer. In the generally adopted production method by anionic polymerization with a vinylating agent, such as dimethyl ether, and subsequent hydrogenation reaction, a hydrogenate having a high glass transition temperature could not be easily obtained. In consequence, it may not be said that PTL 1 suggests that by using a block copolymer hydrogenate, a resin composition exhibiting a high tan δ intensity in a broad temperature range can be obtained.

Then, a problem of the present invention is to provide a resin composition exhibiting a loss tangent (tan δ) of high intensity in a broad temperature range.

### Solution to Problem

The present inventor has found that the aforementioned problem may be solved by a resin composition including a component (x) that is a hydrogenate (X) of a block copolymer having a polymer block (A-1) containing a structural unit derived from an aromatic vinyl compound and a polymer block (B-1) containing a structural unit derived from a conjugated diene compound; and a component (y) that is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, wherein glass transition temperatures of the component (x) and the component (y) are regulated to specified ones, respectively, thereby leading to accomplishment of the present invention.

The present invention relates to the following <1> to <19>.

<1> A resin composition including

a component (x) that is a hydrogenate (X) of a block copolymer having a polymer block (A-1) containing a structural unit derived from an aromatic vinyl compound and a polymer block (B-1) containing a structural unit derived from a conjugated diene compound; and

a component (y) that is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, wherein

the resin composition satisfies the following requirements [1] to [3];

[1] a glass transition temperature of the component (x) is −10° C. or higher;

[2] a glass transition temperature of the component (y) is lower than −10° C.; and

[3] a ratio Mx/My of a mass Mx of the component (x) to a mass My of the component (y) in the resin composition is 1/99 to 99/1.

<2> The resin composition as set forth above in <1>, wherein the content of the polymer block (A-1) in the component (x) is 18% by mass or less.
<3> The resin composition as set forth above in <1> or <2>, wherein a hydrogenation rate of the component (x) is 85 mol % or more.
<4> The resin composition as set forth above in any one of <1> to <3>, wherein a weight average molecular weight of the component (x) is 100,000 to 250,000.
<5> The resin composition as set forth above in any one of <1> to <4>, wherein a melt flow rate of the component (x) as measured under a load of 2,160 g at 230° C. in conformity with JIS K7210:2014 is 30 g/10 min or less.
<6> The resin composition as set forth above in any one of <1> to <5>, wherein the polymer block (B-1) includes a structural unit derived from isoprene.
<7> The resin composition as set forth above in any one of <1> to <6>, wherein the content of a structural unit derived from styrene of the polymer block (B-1) is 5% by mass or less.
<8> The resin composition as set forth above in any one of <1> to <7>, wherein a vinyl bond amount of the polymer block (B-1) is 65 mol % or more.
<9> The resin composition as set forth above in any one of <1> to <8>, wherein the content of the polymer block (A-2) in the component (y) is 35% by mass or less.
<10> The resin composition as set forth above in any one of <1> to <9>, wherein the component (y) is the hydrogenate (Y) of the block copolymer, and a hydrogenation rate of the hydrogenate (Y) of the block copolymer is 85 mol % or more.
<11> The resin composition as set forth above in any one of <1> to <10>, wherein a weight average molecular weight of the component (y) is 40,000 to 500,000.
<12> The resin composition as set forth above in any one of <1> to <11>, wherein the polymer block (B-2) includes a structural unit derived from isoprene.
<13> The resin composition as set forth above in any one of <1> to <12>, wherein the glass transition temperature of the component (y) is lower than −40° C.
<14> The resin composition as set forth above in any one of <1> to <12>, wherein the glass transition temperature of the component (y) is −40° C. or higher.
<15> The resin composition as set forth above in any one of <1> to <14>, wherein the Mx/My is 30/70 to 95/5.
<16> The resin composition as set forth above in any one of <1> to <13> and <15>, wherein the component (x) includes two kinds of the hydrogenate (X) of the block copolymer.
<17> The resin composition as set forth above in any one of <1> to <13>, <15>, and <16>, wherein

polypropylene is further included as a component (z1); and

a paraffin oil is further included as a component (z2).

<18> The resin composition as set forth above in any one of <1> to <17>, wherein a full width at half maximum of the resin composition relative to a peak intensity of tan δ as measured under conditions of a strain amount of 0.1%, a frequency of 1 Hz, a measurement temperature of −70 to +50° C., and a rate of temperature increase of 3° C./min in conformity with JIS K7244-10 (2005) is 20° C. or more.
<19> The resin composition as set forth above in any one of <1> to <15>, wherein a serial temperature range where a tan δ of the resin composition as measured under conditions of a strain amount of 0.1%, a frequency of 1 Hz, a measurement temperature of −30 to +50° C., and a rate of temperature increase of 3° C./min in conformity with JIS K7244-10 (2005) becomes 0.15 or more is existent, and a total width of the temperature range is 30° C. or more.

### Advantageous Effects of Invention

In accordance with the present invention, it is possible to provide a resin composition exhibiting a loss tangent (tan δ) of high intensity in a broad temperature range.

### BRIEF DESCRIPTION OF DRAWINGS

FIG. 1 is a graph expressing temperature characteristics of tan δ of the resin compositions obtained in Examples 1 to 3 and Comparative Examples 1 to 2.

FIG. 2 is a graph expressing temperature characteristics of tan δ of the resin compositions obtained in Example 4 and Comparative Example 3.

### DESCRIPTION OF EMBODIMENTS

Embodiments of the present invention are hereunder described.

Embodiments of arbitrarily selecting the matters described in this specification or embodiments of arbitrarily combining them are included in the present invention.

In this specification, preferable prescription can be arbitrarily selected and the combination of preferable prescriptions is more preferable.

In this specification, the description “XX to YY” means “XX or more and YY or less”.

In this specification, with respect to preferred numerical values ranges (for example, a range of the content), the lower limit value and the upper limit value that are described stepwise can be each independently combined. For example, from the description “preferably 10 to 90, and more preferably 30 to 60”, the “preferred lower limit value (10)” and the “more preferred upper limit value (60)” can be combined to express “10 to 60”.

### Resin Composition

The resin composition according to an embodiment of the present invention is a resin composition including a component (x) that is a hydrogenate (X) of a block copolymer having a polymer block (A-1) containing a structural unit derived from an aromatic vinyl compound and a polymer block (B-1) containing a structural unit derived from a conjugated diene compound; and a component (y) that is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, wherein the resin composition satisfies the following requirements [1] to [3];

[1] a glass transition temperature of the component (x) is −10° C. or higher;

[2] a glass transition temperature of the component (y) is lower than −10° C.; and

[3] a ratio Mx/My of a mass Mx of the component (x) to a mass My of the component (y) in the resin composition is 1/99 to 99/1.

In view of the fact that the resin composition satisfies the requirements [1] to [3], in a curve showing a change of tan δ relative to the temperature, a gentle one peak is shown, or two peaks are shown, as compared with the case of the component (x) alone or the case of the component (y) alone. As a result, the aforementioned resin composition has a high loss tangent (tan δ) in a broad temperature range. According to this, the vibration damping performance can be increased over a wide temperature range including room temperature.

In particular, the present inventor has found that by adopting a block copolymer hydrogenate as the component (x) having a high glass transition temperature as compared with the component (y), the tan δ of high intensity is exhibited in a broader temperature range. Then, they have paid attention to the facts that as for the component (x) suitable for such a resin composition, by adopting a specified production method, a block copolymer hydrogenate having a relatively high glass transition temperature is obtained, thereby leading to accomplishment of the present invention.

### Glass Transition Temperatures (Tg) of Component (x) and Component (y)

The component (x) is a hydrogenate (X) of a block copolymer including a polymer block (A-1) containing a structural unit derived from an aromatic vinyl compound and a polymer block (B-1) containing a structural unit derived from a conjugated diene compound and satisfies the aforementioned requirement [1].

The component (y) is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, and satisfies the aforementioned requirement [2].

In view of the fact that the component (x) satisfies the requirement [1], the intensity of tan δ in the vicinity of room temperature and on the higher temperature side than room temperature can be increased, and in view of the fact that the component (y) satisfies the requirement [2], the intensity of tan δ on the lower temperature side than room temperature can be increased. As a result, the intensity of tan δ in a broad temperature range including room temperature becomes high.

In this specification, Tg of the component (x) and Tg of the component (y) are measured with a differential scanning calorimeter (DSC). Specifically, in a DSC curve prepared using DSC, a temperature at which a shift of the baseline is generated is defined as Tg. In more detail, Tg of the component (x) and Tg of the component (y) are measured according to the method described in the section of Examples.

From the viewpoint of increasing the intensity of tan δ in the vicinity of room temperature and on the higher temperature side than room temperature and the viewpoint of easiness in production, Tg of the component (x) is preferably −10 to +40° C., more preferably −5 to +30° C., and still more preferably 0 to 25° C.

From the viewpoint of increasing the intensity of tan δ on the lower temperature side than room temperature, Tg of the component (y) is preferably −40 to −10° C., more preferably −30 to −11° C., and still more preferably −20 to −13° C. In addition, from the viewpoint of flexibility at a low temperature, Tg of the component (y) is preferably −65 to −40° C., more preferably −60 to −45° C., and still more preferably −58 to −50° C.

From the viewpoint of making it easy to secure the high tan δ intensity in a broad temperature range including room temperature, a difference between Tg of the component (x) and Tg of the component (y) is preferably 5 to 55° C., more preferably 10 to 50° C., and still more preferably 15 to 45° C. In addition, from the viewpoint of making both the vibration damping performance and the flexibility at a low temperature compatible with each other, the forgoing difference is preferably 50 to 90° C., more preferably 55 to 85° C., and still more preferably 59 to 80° C.

### Content Ratio of Component (x) and Component (y)

As prescribed in the aforementioned requirement [3], a ratio Mx/My of a mass Mx of the component (x) to a mass My of the component (y) in the resin composition is 1/99 to 99/1.

In view of the fact that the mass ratio Mx/My falls within the aforementioned range, a high tan δ is obtained on the lower temperature side mainly due to the presence of the component (y), and a high tan δ is obtained on the temperature side of room temperature or higher due to the presence of the component (x). As a result, the intensity of tan δ can be increased in a broad temperature range including room temperature.

From the viewpoint of mechanical properties of the resin composition and impact resistance in a broad temperature range, the mass ratio Mx/My is preferably 30/70 to 95/5, more preferably 35/65 to 90/10, still more preferably 40/60 to 80/20, yet still more preferably 45/55 to 70/30, and especially preferably 45/55 to 60/40.

Incidentally, in an embodiment of the present invention, the total content of the component (x) and the component (y) in the foregoing composition is preferably 50% by mass or more, more preferably 60% by mass or more, still more preferably 80% by mass or more, especially preferably 90% by mass or more, and most preferably 95% by mass or more.

### Component (x)

The component (x) is a hydrogenate (X) of a block copolymer including a polymer block (A-1) containing a structural unit derived from an aromatic vinyl compound and a polymer block (B-1) containing a structural unit derived from a conjugated diene compound, and satisfies the aforementioned requirement [1].

In order that the component (x) may satisfy the requirement [1], for example, by controlling a vinyl bond amount of the conjugated diene compound of the polymer block (B-1) constituting the block copolymer hydrogenate to an appropriate value, Tg of the component (x) can be allowed to fall within the aforementioned range.

The component (x) may include two kinds of the hydrogenate (X) of the block copolymer.

When the component (x) includes two kinds of the hydrogenate (X) of the block copolymer, it becomes easy to broaden a full width at half maximum of tan δ of the resin composition.

The content of the polymer block (A-1) in the component (x) (in the case of including a plurality of the polymer block (A-1), the total content is meant) is preferably 18% by mass or less, more preferably 16% by mass or less, still more preferably 15% by mass or less, and yet still more preferably 13% by mass or less from the viewpoint of vibration damping performance, and it is preferably 3% by mass or more, more preferably 5% by mass or more, and still more preferably 7% by mass or more from the viewpoint of mechanical properties. In other words, the content of the polymer block (A-1) in the hydrogenate (X) of the block copolymer that is the component (x) is preferably 3 to 18% by mass.

The content of the polymer block (A-1) in the component (x) is a value measured through the ¹H-NMR measurement, and in more detail, it is a value measured according to the method described in the section of Examples. The same is also applicable to the content of the polymer block (A-2) in the component (y) as mentioned later.

From the viewpoint of heat resistance and moldability, the weight average molecular weight of the component (x) is preferably 50,000 to 400,000, more preferably 100,000 to 300,000, still more preferably 120,000 to 250,000, and yet still more preferably 130,000 to 200,000.

Any of the “weight average molecular weight” described in this specification and the scope of claims is a weight average molecular weight expressed in terms of standard polystyrene as determined through gel permeation chromatography (GPC), and a detailed measurement method can be made according to the method described in the section of Examples.

The weight average molecular weight of the hydrogenated block copolymer (X) as the component (x) can be, for example, allowed to fall within the aforementioned range by regulating the monomer amounts relative to a polymerization initiator.

### Component (y)

The component (y) is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof and satisfies the aforementioned requirement [2].

In order that the component (y) may satisfy the requirement [2], for example, by controlling a vinyl bond amount of the conjugated diene compound of the polymer block (B-2) constituting the block copolymer or its hydrogenate to an appropriate value, Tg of the component (y) can be allowed to fall within the aforementioned range.

The content of the polymer block (A-2) in the component (y) is preferably 35% by mass or less, more preferably 33% by mass or less, and still more preferably 32% by mass or less from the viewpoint of vibration damping performance in a low-temperature range, and it is preferably 10% by mass or more, more preferably 12% by mass or more, and still more preferably 15% by mass or more from the viewpoint of mechanical properties. In other words, the content of the polymer block (A-2) in the block copolymer (Y0) or its hydrogenate (Y) that is the component (y) is preferably 10 to 35% by mass.

From the viewpoint of heat resistance and moldability, the weight average molecular weight of the component (y) is preferably 40,000 to 600,000, more preferably 60,000 to 500,000, still more preferably 80,000 to 400,000, and yet still more preferably 100,000 to 350,000.

The weight average molecular weight of the block copolymer (Y0) and the hydrogenated block copolymer (Y) as the component (y) can be, for example, allowed to fall within the aforementioned range by regulating the monomer amounts relative to a polymerization initiator.

Common configurations and physical properties of the component (x) and the component (y), other components constituting the resin composition, physical properties of the resin composition, and so on are hereunder described. First of all, the block copolymers to be used for obtaining the component (x) and the component (y) are described.

### Block Copolymers (X0) and (Y0)

A block copolymer before hydrogenation in order to give the hydrogenate (X) of the block copolymer as the component (x), which is included in the resin composition according to an embodiment of the present invention (the foregoing block copolymer will be hereinafter referred to as “block copolymer (X0)”), includes a polymer block (A-1) containing a structural unit derived from an aromatic vinyl compound and a polymer block (B-1) containing a structural unit derived from a conjugated diene compound. In addition, a block copolymer as the component (y), which is included in the resin composition according to an embodiment of the present invention or a block copolymer before hydrogenation in order to give the hydrogenate (Y) of the block copolymer as the component (y) (block copolymer (Y0)) includes a polymer block (A-2) containing a structural unit derived from an aromatic vinyl compound and a polymer block (B-2) containing a structural unit derived from a conjugated diene compound.

The polymer block (A-1) and the polymer block (A-2) are hereinafter collectively referred to as “polymer block (A)”. In addition, the polymer block (B-1) and the polymer block (B-2) are hereinafter collectively referred to as “polymer block (B)”. Then, with respect to the block copolymer according to the component (x) and the block copolymer according to the component (y), common portions are collectively described.

### Polymer Block (A)

The polymer block (A) contains a structural unit derived from an aromatic vinyl compound (hereinafter occasionally abbreviated as “aromatic vinyl compound unit”), and from the viewpoint of mechanical properties, the content thereof is preferably more than 70 mol %, more preferably 80 mol % or more, still more preferably 85 mol % or more, yet still more preferably 90 mol % or more, and especially preferably 95 mol % or more, and it may also be substantially 100 mol %.

Examples of the aromatic vinyl compound include styrene, o-methylstyrene, m-methylstyrene, p-methylstyrene, α-methylstyrene, β-methylstyrene, 2,6-dimethylstyrene, 2,4-dimethylstyrene, α-methyl-o-methylstyrene, α-methyl-m-methylstyrene, α-methyl-p-methylstyrene, β-methyl-o-methylstyrene, β-methyl-m-methylstyrene, β-methyl-p-methylstyrene, 2,4,6-trimethylstyrene, α-methyl-2,6-dimethylstyrene, α-methyl-2,4-dimethylstyrene, β-methyl-2,6-dimethylstyrene, β-methyl-2,4-dimethylstyrene, o-chlorostyrene, m-chlorostyrene, p-chlorostyrene, 2,6-dichlorostyrene, 2,4-dichlorostyrene, α-chloro-o-chlorostyrene, α-chloro-m-chlorostyrene, α-chloro-p-chlorostyrene, β-chloro-o-chlorostyrene, β-chloro-m-chlorostyrene, β-chloro-p-chlorostyrene, 2,4,6-trichlorostyrene, α-chloro-2,6-dichlorostyrene, α-chloro-2,4-dichlorostyrene, β-chloro-2,6-dichlorostyrene, β-chloro-2,4-dichlorostyrene, o-t-butylstyrene, m-t-butylstyrene, p-t-butylstyrene, o-methoxystyrene, m-methoxystyrene, p-methoxystyrene, o-chloromethylstyrene, m-chloromethylstyrene, p-chloromethylstyrene, o-bromomethylstyrene, m-bromomethylstyrene, p-bromomethylstyrene, silyl group-substituted styrene derivatives, indene, and vinylnaphthalene. These aromatic vinyl compound may be used alone or may be used in combination of two or more thereof. Above all, from the viewpoint of a balance of production cost and physical properties, styrene, α-methylstyrene, p-methylstyrene, and a mixture thereof are preferred, and styrene is more preferred.

However, so far as the object and effects of the present invention are not impaired, the polymer block (A) may contain a structural unit derived from other unsaturated monomer than the aromatic vinyl compound (this will be occasionally abbreviated as “other unsaturated monomer unit”) in a proportion of less than 30 mol %. Examples of the other unsaturated monomer include at least one selected from the group consisting of butadiene, isoprene, 2,3-dimethylbutadiene, 1,3-pentadiene, 1,3-hexadiene, isobutylene, methyl methacrylate, methyl vinyl ether, N-vinylcarbazole, β-pinene, 8,9-p-menthene, dipentene, methylene norbornene, and 2-methylene tetrahydrofuran. The bonding mode in the case where the polymer block (A) contains the other unsaturated monomer unit is not particularly restricted, and it may be any of a random form or a tapered form.

The content of the structural unit derived from the other unsaturated monomer in the polymer block (A) is preferably 10 mol % or less, more preferably 5 mol % or less, and still more preferably 0 mol %.

The block copolymer may have the aforementioned at least one polymer block (A). In the case where the block copolymer has two or more polymer blocks (A), these polymer blocks (A) may be the same as or different from each other. In this description, the wording “polymer blocks differ” means that polymer blocks differ in at least one of the monomer unit constituting the polymer block, the weight average molecular weight, and the stereoregularity, and when the polymer block has plural monomer units, the ratio of each monomer unit and the copolymerization conformation (random, gradient, or block).

Preferably, the block copolymer has the two polymer blocks (A).

Although the weight average molecular weight (Mw) of the polymer block (A) is not particularly limited, the weight average molecular weight of at least one polymer block (A) among the polymer blocks (A) that the block copolymer has is preferably 3,000 to 60,000, and more preferably 4,000 to 50,000. In view of the fact that the block copolymer has at least one polymer block (A) whose weight average molecular weight falls within the aforementioned range, the mechanical strength is more improved, and excellent flowability and film formability are provided.

The weight average molecular weight of each polymer block that the block copolymer has can be determined by measuring a liquid that is to be sampled every time of completion of polymerization of each polymer block in the production step. In addition, for example, when the two kinds of polymer block (A) are represented as “A1” and “A2”, and the one kind of polymer block (B) is represented as “(B)”, in the case of a triblock copolymer having a configuration A1-B-A2, the weight average molecular weights of the polymer block “A1” and the polymer bock “B” are determined according to the aforementioned method, and the resultant data are subtracted from the weight average molecular weight of the block copolymer, whereby the weight average molecular weight of the polymer block “A2” can be determined. As another method, in the case of a triblock copolymer having the aforementioned configuration A1-B-A2, the total weight average molecular weight of the polymer blocks “A1” and “A2” is calculated from the weight average molecular weight of the block copolymer and the total content of the polymer blocks “A1” and “A2” confirmed through the ¹H-NMR measurement, and the weight average molecular weight of the deactivated first polymer block “A1” is calculated through the GPC measurement, followed by carrying out subtraction, whereby the weight average molecular weight of the polymer block “A2” can also be determined.

### Polymer Block (B)

The polymer block (B) contains a structural unit derived from a conjugated diene compound (hereinafter occasionally abbreviated as “conjugated diene compound unit”).

Examples of the conjugated diene compound constituting the conjugated diene compound unit include butadiene and isoprene. The conjugated diene compound may be used alone or may be used in combination of two or more thereof.

Preferably, the polymer block (B-1) includes a structural unit derived from isoprene, and for example, as the conjugated diene compound, isoprene can be used alone, or a mixture of isoprene and butadiene can be used.

Preferably, the polymer block (B-2) includes a structural unit derived from isoprene, and for example, as the conjugated diene compound, isoprene may be used alone, or a mixture of isoprene and butadiene may be used.

From the viewpoint of flexibility and rubber elasticity, the content of the conjugated diene compound unit in the polymer block (B) is preferably 60% by mass or more, more preferably 70% by mass or more, still more preferably 80% by mass or more, and especially preferably 90% by mass or more. An upper limit thereof is not particularly restricted, and it can be made to 100% by mass. In other words, the total content of the structural units derived from the conjugated diene compounds in the polymer block (B) is preferably 60 to 100% by mass.

The content of the conjugated diene compound unit in the polymer block (B) is preferably 30 mol % or more, more preferably 50 mol % or more, still more preferably 65 mol % or more, yet still more preferably 80 mol % or more, especially preferably 90 mol % or more, and most preferably substantially 100 mol % in terms of a molar amount.

In the case of using a mixture of butadiene and isoprene as the conjugated diene compound, though a mixing ratio of the both [butadiene/isoprene] (mass ratio) is not particularly restricted so far as the effects of the present invention are not impaired, it is preferably 5/95 to 95/5, more preferably 10/90 to 90/10, still more preferably 15/85 to 50/50, and especially preferably 18/82 to 45/55.

When the foregoing mixing ratio [butadiene/isoprene] is expressed in terms of a molar ratio, it is preferably 5/95 to 95/5, more preferably 10/90 to 90/10, still more preferably 40/60 to 80/20, and especially preferably 45/55 to 75/25.

The polymer block (B) may contain a structural unit derived from other polymerizable monomer than the conjugated diene compound so far as the effects of the present invention are not impaired. In this case, in the polymer block (B), the content of the structural unit derived from the polymerizable monomer other than the conjugated diene compound is preferably 70 mol % or less, more preferably 50 mol % or less, still more preferably 35 mol % or less, and especially preferably 20 mol % or less. Although a lower limit value of the content of the structural unit derived from the polymerizable monomer other than the conjugated diene compound is not particularly restricted, it may be 0 mol % or more, may be 5 mol % or more, or may be 10 mol % or more.

For example, the other polymerizable monomer is preferably at least one compound selected from the group consisting of aromatic vinyl compounds, such as styrene, α-methylstyrene, o-methylstyrene, m-methylstyrene, p-methylstyrene, p-t-butylstyrene, 2,4-dimethylstyrene, vinylnaphthalene, and vinylanthracene, as well as methyl methacrylate, methyl vinyl ether, N-vinylcarbazole, β-pinene, 8,9-p-menthene, dipentene, methylene norbornene, 2-methylene tetrahydrofuran, 1,3-cyclopentadiene, 1,3-cyclohexadiene, 1,3-cycloheptadiene, and 1,3-cyclooctadiene. Above all, styrene, α-methylstyrene, and p-methylstyrene are more preferred, and styrene is still more preferred.

In the case where the polymer block (B) contains a structural unit derived from the other polymerizable monomer than the conjugated diene compound, the bonding form is not particularly restricted and may be any of a random or tapered form, but it is preferably a random form.

The block copolymer has the aforementioned at least one polymer block (B). In the case where the block copolymer has two or more polymer blocks (B), these polymer blocks (B) may be the same as or different from each other. In the case where the polymer block (B) has two or more kinds of structural units, the bonding form thereof may be any of a random, tapered, completely alternate, partly block, or block form or may be a combination of two or more thereof.

The bonding form of the conjugated diene compound is not particularly restricted so far as the object and effects of the present invention are not impaired. For example, in the case where the structural unit constituting the polymer block (B) is a mixture unit of butadiene and isoprene, as for the bonding forms of the respective butadiene and isoprene, butadiene can take any of a 1,2-bond or a 1,4-bond, and isoprene can take any of a 1,2-bond, a 3,4-bond, or a 1,4-bond. Only one kind of these bonding forms may be existent or two or more kinds thereof may be existent.

### Vinyl Bond Amount of Polymer Block (B)

In the case where the structural unit constituting the polymer block (B) is a mixture unit of butadiene and isoprene, as for the bonding forms of the respective butadiene and isoprene, butadiene can take any of a 1,2-bond or a 1,4-bond, and isoprene can take any of a 1,2-bond, a 3,4-bond, or a 1,4-bond. Of these, the 1,2-bond of butadiene and the 1,2-bond and 3,4-bond of isoprene are defined as the vinyl bond, and the content of the vinyl bond unit is defined as the vinyl bond amount.

In the component (x), from the viewpoint of making Tg high, the vinyl bond amount in the polymer block (B-1) is preferably 65 mol % or more, more preferably 70 mol % or more, and still more preferably 75 mol % or more. In addition, though an upper limit value of the vinyl bond amount in the polymer block (B) is not particularly restricted, from the viewpoint of easiness in production, it may be 95 mol % or less or may be 90 mol % or less. In other words, the vinyl bond amount in the polymer block (B-1) is preferably 65 to 95 mol %.

In the component (y), from the viewpoint of increasing the intensity of tan δ on the lower temperature side than room temperature, the vinyl bond amount in the polymer block (B-2) is preferably 40 to 80 mol %, more preferably 50 to 70 mol %, and still more preferably 55 to 65 mol %. In addition, from the viewpoint of flexibility at a low temperature, it is preferably 1 to 50 mol %, more preferably 2 to 30 mol %, and still more preferably 3 to 10 mol %.

The vinyl bond amount is a value calculated through the ¹N-NMR measurement according to the method described in the section of Examples.

The weight average molecular weight of the polymer block (B) that the block copolymer has is, from the viewpoint of vibration damping performance and the like, in a state before hydrogenation, preferably 15,000 to 800,000, more preferably 20,000 to 600,000, still more preferably 30,000 to 400,000, especially preferably 50,000 to 250,000, and most preferably 70,000 to 200,000.

The block copolymer has the aforementioned at least one polymer block (B). In the case where the block copolymer has two or more polymer blocks (B), these polymer blocks (B) may be the same as or different from each other.

Preferably, the block copolymer has only one of the polymer block (B).

In the aforementioned component (x) and component (y), it is preferred that the content of the structural unit derived from the aromatic vinyl compound in the polymer block (B) is small, and it is desired that the foregoing structural unit is not included. When the structural unit derived from the aromatic vinyl compound is included in the polymer block (B), the vibration damping performance is occasionally lowered.

From the aforementioned viewpoint, the content of the structural unit derived from styrene of the polymer block (B-1) is preferably 5% by mass or less, more preferably 2% by mass or less, still more preferably 1% by mass or less, and especially preferably 0% by mass.

Similarly, the content of the structural unit derived from styrene of the polymer block (B-2) is preferably 5% by mass or less, more preferably 2% by mass or less, still more preferably 1% by mass or less, and especially preferably 0% by mass.

### Bonding Mode of Polymer Block (A) and Polymer Block (B)

So far as the polymer block (A) and the polymer block (B) bond in the block copolymer, the bonding mode thereof is not particularly limited, and it may be any bonding mode of a linear, branched, or radial bonding mode or a bonding mode of a combination of two or more thereof. Above all, the bonding form of the polymer block (A) and the polymer block (B) is preferably a linear one, and examples thereof include a diblock copolymer represented by A-B where the polymer block (A) is represented by A, and the polymer block (B) is by B, a triblock copolymer represented by A-B-A or B-A-B, a tetrablock copolymer represented by A-B-A-B, a pentablock copolymer represented by A-B-A-B-A or B-A-B-A-B, and an (A-B)ₙX-type copolymer (where X represents a coupling agent residue, and n represents an integer of 3 or more). Above all, a linear triblock copolymer or a diblock copolymer is preferred, and a triblock copolymer of a type of A-B-A is preferably used from the viewpoint of flexibility and easiness in production.

Here, in this specification, in the case where polymer blocks of the same type bond linearly via a bifunctional coupling agent or the like, all the bonding polymer blocks are handled as one polymer block. Accordingly, including the aforementioned exemplifications, a polymer block that is, in nature, strictly expressed as Y-X-Y (wherein X represents a coupling agent residue) is expressed as Y as a whole, excepting a case that needs to be differentiated from a polymer block Y alone. In this specification, the polymer block of the type including a coupling agent residue is handled as above, and therefore, for example, a block copolymer that includes a coupling agent residue and is to be strictly expressed as A-B-X-B-A (wherein X represents a coupling agent residue) is expressed as A-B-A and is handled as one example of a triblock copolymer.

The aforementioned block copolymer may have one or more functional groups, such as a carboxy group, a hydroxy group, an acid anhydride group, an amino group, and an epoxy group, in the molecular chain and/or the molecular terminal so far as the object and effects of the present invention are not impaired, and it may not have a functional group.

### Block Copolymer Hydrogenate

The block copolymer hydrogenate is one resulting through hydrogenation of the block copolymer. In this specification, the block copolymer hydrogenate is also occasionally referred to as “hydrogenated block copolymer”.

All of the block copolymer (X0) for giving the hydrogenated block copolymer (X) and the block copolymer (Y0) for giving the hydrogenated block copolymer (Y) have a structural unit derived from the polymer block (A) and a structural unit derived from the polymer block (B), and even when hydrogenation is carried out, those main structures do not change. Accordingly, with respect to the descriptions regarding the structural components of the aforementioned block copolymers and use ratios thereof, and characteristics, and so on, the descriptions regarding the following polymer block (A-1) and polymer block (A-2) are also common to the hydrogenated block copolymer (X) and the hydrogenated block copolymer (Y) unless specifically indicated.

The hydrogenation rate of the polymer block (B) is preferably 85 mol % or more. Namely, it is preferred that 85 mol % or more of carbon-carbon double bonds that the polymer block (B) has are hydrogenated.

When the hydrogenation rate of the polymer block (B) is high, excellent vibration damping performance, heat resistance, and weather resistance at a broad temperature are provided. From the same viewpoint, the hydrogenation rate of the polymer block (B) is more preferably 86 mol % or more, still more preferably 87 mol % or more, and yet still more preferably 88 mol % or more. Although an upper limit value of the hydrogenation rate is not particularly restricted, it may be 99 mol % or may be 98 mol %. In other words, the hydrogenation rate of the block copolymer (B) is preferably 85 to 99 mol %.

From the same viewpoint, the hydrogenation rate of the component (x) is preferably 85 mol % or more, more preferably 86 mol % or more, still more preferably 87 mol % or more, and yet still more preferably 88 mol % or more, and an upper limit value thereof is, for example, 99 mol % or less, and it may be 98 mol % or less. In other words, the hydrogenation rate of the component (x) is preferably 85 to 99 mol %.

From the same viewpoint, in the case where the component (y) is the hydrogenate (Y) of the block copolymer, the hydrogenation rate of the block copolymer (Y) is preferably 85 mol % or more, more preferably 87 mol % or more, still more preferably 88 mol % or more, and yet still more preferably 89 mol % or more, and an upper limit value thereof is, for example, 99 mol % or less, and it may be 98 mol % or less. In other words, the hydrogenation rate of the block copolymer (Y) is preferably 85 to 99 mol %.

The hydrogenation rate is a value determined by measuring the content of the carbon-carbon double bonds in the structural unit derived from the conjugated diene compound in the polymer block (B) through the ¹H-NMR measurement after hydrogenation, and in more detail, this is a value measured according to the method described in the section of Examples.

The aforementioned hydrogenated block copolymer may have one or more functional groups, such as a carboxy group, a hydroxy group, an acid anhydride group, an amino group, and an epoxy group, in the molecular chain and/or the molecular terminal so far as the object and effects of the present invention are not impaired, and it may not have a functional group.

### Physical Properties of Hydrogenated Block Copolymer

As for the peak top intensity of a loss tangent tan δ of the hydrogenated block copolymer as measured under conditions of a strain amount of 0.1%, a frequency of 1 Hz, a measurement temperature of −30 to +50° C., a rate of temperature increase of 3° C./min, and a shear mode in conformity with JIS K7244-10 (2005), it is shown that the larger the numerical value thereof, the more excellent the physical properties, such as vibration damping performance at that temperature, and when it is 1.0 or more, sufficient vibration performance can be provided in actual use environments. The peak top intensity of tan δ is preferably 1.0 or more, more preferably 1.5 or more, and still more preferably 1.9 or more. In the case where the resin composition obtained by mixing the component (x) and the component (y) exhibits expected physical properties, at least the peak top intensity of tan δ of the hydrogenated block copolymer (Y) may fall outside the aforementioned range.

The peak top temperature of a loss tangent tan δ of the hydrogenated block copolymer (X) as measured under conditions of a strain amount of 0.1%, a frequency of 1 Hz, a measurement temperature of −30 to +50° C., a rate of temperature increase of 3° C./min, and a shear mode in conformity with JIS K7244-10 (2005) is preferably +45° C. or lower, more preferably +40° C. or lower, and still more preferably +35° C. or lower from the viewpoint of vibration damping performance in the vicinity of room temperature and on the higher temperature range than room temperature. Although a lower limit of the peak top temperature of tan δ of the hydrogenated block copolymer (X) is not particularly restricted, it is, for example, +5° C. from the viewpoint of easiness in production. In other words, the peak top temperature of tan δ of the hydrogenated block copolymer (X) is preferably +5 to +45° C.

The peak top temperature of the loss tangent tan δ of the hydrogenated block copolymer (Y) as measured by the aforementioned procedures is preferably −2° C. or lower, more preferably −4° C. or lower, and still more preferably −6° C. or lower from the viewpoint of vibration damping performance and securing sufficient flexibility and rubber elasticity in a low-temperature range. Although a lower limit of the peak top temperature of tan δ of the hydrogenated block copolymer (Y) is not particularly restricted, it is, for example, −70° C. from the viewpoint of easiness in production. In other words, the peak top temperature of tan δ of the hydrogenated block copolymer (Y) is preferably −70 to −2° C.

The peak top intensity of tan δ refers to a value of tan δ when the peak of tan δ becomes maximum. In addition, the peak top temperature of tan δ refers to a temperature at which the peak of tan δ becomes maximum. Specifically, the peak top temperature and the peak top intensity of tan δ of the hydrogenated block copolymer are measured by the method described in the section of Examples.

In order to regulate these values to the aforementioned ranges, for example, there are exemplified the adjustment of the kind and ratio of the conjugated diene compound that is a monomer constituting the polymer block (B) and the adjustment of the vinyl bond amount of the polymer block (B).

A melt flow rate of the hydrogenated block copolymer (X) that is the component (x) as measured under a load of 2,160 g at 230° C. in conformity with JIS K7210:2014 is preferably 30 g/10 min or less, more preferably 25 g/10 min or less, and still more preferably 20 g/10 min or less from the viewpoint of easiness in production, and it is preferably 0.5 g/10 min or more, more preferably 0.7 g/10 min or more, and still more preferably 0.9 g/10 min or more from the viewpoint of easiness in molding of the resin composition.

A melt flow rate of the hydrogenated block copolymer (Y) that is the component (y) as measured under a load of 2,160 g at 230° C. in conformity with JIS K7210:2014 is preferably 30 g/10 min or less, more preferably 20 g/10 min or less, and still more preferably 10 g/10 min or less from the viewpoint of mechanical properties, and it is preferably 0.5 g/10 min or more, more preferably 0.7 g/10 min or more, and still more preferably 0.9 g/10 min or more from the viewpoint of easiness in molding of the resin composition.

### Other Resin Component

The resin composition according to an embodiment of the present invention may include, as other resin component (z1), at least one selected from the group consisting of a polyolefin, such as polyethylene and polypropylene, a styrenic resin, a polyphenylene ether, a polyester resin, a polycarbonate, a polyacetal, a polyamide, a polyarylene sulfide, a polyarylate, a polyimide, a polyetheretherketone, and a liquid crystal polyester.

The aforementioned resin composition may further include as other resin component than the aforementioned component (x), component (y), and component (z1), a hydrogenated resin, such as a hydrogenated chroman/indene resin, a hydrogenated rosin-based resin, a hydrogenated terpene resin, and an alicyclic hydrogenated petroleum resin; a tackifying resin, such as an aliphatic resin composed of an olefin or diolefin polymer; and other polymer, such as a hydrogenated polyisoprene, a hydrogenated polybutadiene, a butyl rubber, polyisoprene, and polybutene, within a range where the effects of the present invention are not impaired.

In the case where the aforementioned resin composition contains other resin component than the component (x), the component (y), and the component (z1), though there are no particular restrictions, the content of the other resin component than the component (x), the component (y), and the component (z1) in the foregoing composition is preferably 50% by mass or less. Then, in that case, from the viewpoint of vibration damping performance, the total content of the component (x) and the component (y) in the foregoing composition is preferably 50% by mass or more, more preferably 60% by mass or more, still more preferably 80% by mass or more, especially preferably 90% by mass or more, and most preferably 95% by mass or more.

### Additives

Examples of other component (component (z2)) than the resin components which may be included in the aforementioned resin composition include additives, such as an antioxidant, a UV absorbent, a light stabilizer, a heat shield, an antiblocking material, a pigment, a dye, a softening agent, a crosslinking material, a crosslinking aid, a crosslinking accelerator, a filler, a reinforcing agent, a lubricant, an antistatic agent, a flame retardant, a foaming agent, a water repellent, a waterproofing agent, an electric conductivity imparting agent, a thermal conductivity imparting agent, an electromagnetic wave shielding performance imparting agent, a fluorescent agent, and an antibacterial agent. However, it should be construed that the present invention is not limited thereto. These may be used alone or may be used in combination of two or more thereof.

Examples of the antioxidant include a phenolic antioxidant, a phosphorus-based antioxidant, and a sulfur-based antioxidant.

Examples of the UV absorbent include a benzotriazole-based UV absorbent, a hindered amine-based UV absorbent, and a benzoate-based UV absorbent, and in addition, a triazine-based compound, a benzophenone-based compound, a malonate compound, and an oxalic acid anilide compound are also usable.

Examples of the light stabilizer include a hindered amine-based light stabilizer.

Examples of the heat shield include a material prepared by allowing a resin or glass to contain heat ray-shielding particles having a heat ray-shielding function or an organic dye compound having a heat ray-shielding function. Examples of the particles having a heat ray-shielding function include particles of an oxide, such as tin-doped indium oxide, antimony-doped tin oxide, aluminum-doped zinc oxide, tin-toped zinc oxide, and silicon-doped zinc oxide; and particles of an inorganic material having a heat ray-shielding function, such as LaB₆ (lanthanum hexaboride) particles. In addition, examples of the organic dye compound having a heat ray-shielding function include a diimmonium-based dye, an aminium-based dye, a phthalocyanine-based dye, an anthraquinone-based dye, a polymethine-based dye, a benzenedithiol-type ammonium-based compound, a thiourea derivative, and a thiol metal complex.

Examples of the antiblocking agent include inorganic particles and organic particles. Examples of the inorganic particles include particles of IA Group, IIA Group, IVA Group, VIA Group, VITA Group, VIIIA Group, IB Group, IIB Group, IIIB Group, or IVB Group element oxides, hydroxides, sulfides, nitrides, halides, carbonates, sulfates, acetates, phosphates, phosphites, organic carboxylates, silicates, titanates, and borates, and hydrated compounds thereof, as well as composite compounds having any of these as a center, and natural mineral particles. Examples of the organic particles include a fluorine resin, a melamine-based resin, a styrene-divinylbenzene copolymer, an acrylic resin silicone, and crosslinked bodies thereof.

Examples of the pigment include an organic pigment and an inorganic pigment. Examples of the organic pigment include an azo-based pigment, a quinacridone-based pigment, and a phthalocyanine-based pigment. Examples of the inorganic pigment include titanium oxide, zinc oxide, zinc sulfide, carbon black, a lead-based pigment, a cadmium-based pigment, a cobalt-based pigment, an iron-based pigment, a chromium-based pigment, ultramarine, and Prussian blue.

Examples of the dye include an azo-based dye, an anthraquinone-based dye, a phthalocyanine-based dye, a quinacridone-based dye, a perylene-based dye, a dioxazine-based dye, an anthraquinone-based dye, an indolinone-based dye, an isoindolino-based dye, a quinone-imine-based dye, a triphenylmethane-based dye, a thiazole-based dye, a nitro-based dye, and a nitroso-based dye.

The softening agent may be any known softening agent, and examples thereof include hydrocarbon oils, such as a paraffinic hydrocarbon oil, e.g., a paraffin oil, a naphthenic hydrocarbon oil, and an aromatic hydrocarbon-based oil; vegetable oils, such as peanut oil and rosin; phosphates; low-molecular weight polyethylene glycols; liquid paraffins; and hydrocarbon-based synthetic oils, such as a low-molecular weight polyethylene, an ethylene-α-olefin copolymer oligomer, liquid polybutene, liquid polyisoprene or a hydrogenate thereof, and liquid polybutadiene or a hydrogenate thereof. These may be used alone or may be used in combination of two or more thereof.

Examples of the crosslinking agent include a radical generator, sulfur, and a sulfur compound.

Examples of the radical generator include organic peroxides, for example, dialkyl monoperoxides, such as dicumyl peroxide, di-t-butyl peroxide, and t-butylcumyl peroxide; diperoxides, such as 2,5-dimethyl-2,5-di(t-butylperoxy)hexane, 2,5-dimethyl-2,5-di(t-butylperoxy)hexyne-3, bis(t-butyldioxyisopropyl)benzene, 1,1-bis(t-butylperoxy)-3,3,5-trimethylcyclohexane, and n-butyl-4,4-bis(t-butylperoxy)valerate; benzoyl group containing peroxides, such as benzoyl peroxide, p-chlorobenzoyl peroxide, and 2,4-dichlorobenzoyl peroxide; monoacylalkyl peroxides, such as t-butylperoxy benzoate; percarbonates, such as t-butylperoxyisopropyl carbonate; diacyl peroxides, such as diacetyl peroxide and lauroyl peroxide. These may be used alone or may be used in combination of two or more thereof. Above all, 2,5-dimethyl-2,5-di(t-butylperoxy)hexane and dicumyl peroxide are preferred from the viewpoint of reactivity.

Examples of the sulfur compound include sulfur monochloride and sulfur dichloride.

As the crosslinking agent, phenolic resins, such as an alkylphenol resin and a bromoalkylphenol resin; and a combination of p-quinone dioxime and lead dioxide and a combination of p,p′-dibenzoylquinone dioxime and trilead tetroxide are also usable in addition to the above.

The crosslinking aid may be a known crosslinking aid, and examples thereof include polyfunctional monomers, such as trimethylolpropane trimethacrylate, trimethylolpropane triacrylate, triallyl trimellitate, triallyl 1,2,4-benzenetricarboxylate, triallyl isocyanurate, 1,6-hexanediol dimethacrylate, 1,9-nonanediol dimethacrylate, 1,10-decanediol dimethacrylate, polyethylene glycol dimethacrylate, ethylene glycol dimethacrylate, diethylene glycol dimethacrylate, triethylene glycol dimethacrylate, divinylbenzene, glycerol dimethacrylate, and 2-hydroxy-3-acryloyloxypropyl methacrylate; and stannous chloride, ferric chloride, organic sulfonic acids, polychloroprene, and chlorosulfonated polyethylene. The crosslinking aid may be used alone or may be used in combination of two or more thereof.

Examples of the crosslinking accelerator include thiazoles, such as N,N-diisopropyl-2-benzothiazole sulfenamide, 2-mercaptobenzothiazole, and 2-(4-morpholinodithio)benzothiazole; guanidines, such as diphenylguanidine and triphenylguanidine; aldehyde-amine-based reaction products or aldehyde-ammonia-based reaction products, such as a butylaldehyde-aniline reaction product and a hexamethylenetetramine-acetaldehyde reaction product; imidazolines, such as 2-mercaptoimidazoline; thioureas, such as thiocarbanilide, diethylurea, dibutylthiourea, trimethylthiourea, and di-orthotolylthiourea; dibenzothiazyl disulfide; thiuram monosulfides or thiuram polysulfides, such as tetramethylthiuram monosulfide, tetramethylthiuram disulfide, and pentamethylenethiuram tetrasulfide; thiocarbamates, such as zinc dimethyldithiocarbamate, zinc ethylphenyldithiocarbamate, sodium dimethyldithiocarbamate, selenium dimethyldithiocarbamate, and tellurium diethyldithiocarbamate; xanthogenates, such as zinc dibutylxanthogenate; and zinc oxide. The crosslinking accelerator may be used alone or may be used in combination of two or more thereof.

Examples of the filler include inorganic fillers, such as talc, clay, mica, calcium silicate, glass, glass hollow beads, glass fibers, calcium carbonate, magnesium carbonate, basic magnesium carbonate, aluminum hydroxide, magnesium hydroxide, calcium hydroxide, zinc borate, dawsonite, ammonium polyphosphate, calcium aluminate, hydrotalcite, silica, diatomaceous earth, alumina, titanium oxide, iron oxide, zinc oxide, magnesium oxide, tin oxide, antimony oxide, barium ferrite, strontium ferrite, carbon fibers, active carbon, carbon hollow beads, calcium titanate, lead titanate zirconate, silicon carbide, and mica; organic fillers, such as wood powder and starch; electric conductive fillers, such as carbon black, graphite, and carbon nanotube; and metal fillers, such as a silver powder, a copper powder, a nickel powder, a tin powder, copper fibers, stainless steel fibers, aluminum fibers, and iron fibers.

The content of the aforementioned additive which is included in the resin composition is not particularly restricted and can be appropriately adjusted according to the kind of the additive or the like. In the case where the resin composition contains the aforementioned additive, the content of the additive may be, for example, 50% by mass or less, 45% by mass or less, or 30% by mass or less, and it may be 0.01% by mass or more, 0.1% by mass or less, or 1% by mass or more, relative to the total mass of the resin composition.

The component (z1) that is the aforementioned other resin component and the component (z2) that is the additive may be used in combination. For example, a polyolefin, such as polypropylene and a paraffin oil can be used in combination. In this case, since it becomes easy to broaden the temperature range of tan δ exhibiting the predetermined intensity, the resulting resin composition is one suited for wide applications.

### Physical Properties of Resin Composition

Various physical properties that the resin composition according to an embodiment of the present invention has are described.

### Full Width at Half Maximum of tan δ

The full width at half maximum of the resin composition relative to a peak intensity of tan δ as measured under conditions of a strain amount of 0.1%, a frequency of 1 Hz, a measurement temperature of −70 to +50° C., a rate of temperature increase of 3° C./min, and a shear mode in conformity with JIS K7244-10 (2005) is preferably 20° C. or more, more preferably 22° C. or more, and still more preferably 24° C. or more from the viewpoint of securing the predetermined tan δ intensity in a board temperature range.

### Temperature Range where tan δ is 0.15 or More

From the viewpoint of revealing the vibration damping performance in a broad temperature range, preferably, a serial temperature range where a tan δ of the resin composition as measured under conditions of a strain amount of 0.1%, a frequency of 1 Hz, a measurement temperature of −30 to +50° C., a rate of temperature increase of 3° C./min, and a shear mode in conformity with JIS K7244-10 (2005) becomes 0.15 or more is existent, and a total width of the temperature range is preferably 30° C. or more. The total width of the temperature range is more preferably 35° C. or more, and still more preferably 40° C. or more.

The aforementioned temperature range may be continued or may be divided into two or more. In the latter case, the total temperature range width may be 30° C. or more.

### Melt Flow Rate (MFR)

From the viewpoint of easiness in production, the melt flow rate of the aforementioned resin composition as measured under a load of 2,160 g at 230° C. in conformity with JIS K7210:2014 is preferably 20 g/10 min or less, more preferably 15 g/10 min or less, and still more preferably 10 g/10 min or less. Although a lower limit thereof is not particularly restricted, it is, for example, 0.3 g/10 min or more from the viewpoint of easiness in molding.

### Hardness

As for the aforementioned resin composition, its hardness by the type A durometer method in conformity with JIS K6253-2:2012 (hereinafter also referred to as “A-hardness”) is preferably 75 or less, more preferably 70 or less, and still more preferably 65 or less. When the A-hardness is the aforementioned range or less, it becomes easy to provide favorable flexibility, elasticity, and mechanical characteristics.

### Tensile Elongation at Break

With respect to a molded body obtained by injection-molding the resin composition according to an embodiment of the present invention, in the case of measuring an elongation at break (tensile elongation at break) in each of the injection flow direction (MD) and the vertical direction (TD) in conformity with JIS K6251:2010, a ratio of tensile elongation at break of MD and TD [(MD)/(TD)] is preferably 0.4 to 1.4, more preferably 0.5 to 1.2, and still more preferably 0.6 to 1.0.

So far as the ratio [(MD)/(TD)] falls within the aforementioned range, a resin composition having favorable flexibility and excellent grip performance is provided.

The tensile elongations at break of MD and TD are each preferably 250% or more, more preferably 300% or more, still more preferably 350% or more, and yet still more preferably 400% or more.

As for molding conditions on the occasion of obtaining the aforementioned injection-molded body, a cylinder temperature may be about 150 to 300° C., a die temperature may be about 40 to 90° C., and an injection pressure may be about 1 to 200 MPa. From the viewpoint of improving the flexibility and the tensile characteristics, the cylinder temperature is preferably 180 to 250° C., and more preferably 190 to 230° C. In addition, from the same viewpoint as mentioned above, the injection pressure is preferably 1 to 150 MPa, and more preferably 1 to 100 MPa.

In the following description, the tensile strengths at break in the respective flow directions are occasionally referred to as “tensile strength at break (MD)” and “tensile strength at break (TD)”, respectively.

### Tensile Strength at Break

With respect to a molded body obtained by injection-molding the resin composition according to an embodiment of the present invention, in the case of measuring a tensile strength at break (tensile strength at break) in each of MD and TD in conformity with JIS K6251:2010, the tensile strengths at break of MD and TD are each preferably 2.0 MPa or more, more preferably 4.0 MPa or more, and still more preferably 6.0 MPa or more.

So far as the tensile strength at break is 2.0 MPa or more, it is easy to make the tensile characteristics favorable.

In the following description, the tensile elongations at break in the respective flow directions are occasionally referred to as “tensile elongation at break (MD)” and “tensile elongation at break (TD)”, respectively.

### Compression Set

As for the resin composition, a compression set (%) determined according to [100×(d₀−d₂)/(d₀−d₁)] in conformity with JIS K6262 in a manner such that the resin composition is compression-molded at 200° C. for 3 minutes to prepare a test piece having a diameter of 13 mm and a thickness of 6.3 mm (d₀); this test piece is subjected to 25% compression deformation using a spacer having a thickness of 4.8 mm (d₁); after holding under an atmosphere at 70° C. for 22 hours, the compression is released; and the test piece is allowed to stand for 30 minutes under an atmosphere at 24° C. and a relative humidity of 50° C., thereby measuring a thickness (d₂) of the test piece, is preferably 85% or less, more preferably 80% or less, and still more preferably 70% or less from the viewpoint of securing favorable rubber elasticity in the vicinity of room temperature.

A compression set measured in the same manner as mentioned above, except for changing the temperature at the time of compression to 100° C. is preferably 90% or less, more preferably 85% or less, and still more preferably 75% or less.

### Production Method of Block Copolymer

A production method of block copolymers (block copolymers (X0) and (Y0)) which are used for obtaining the resin composition according to an embodiment of the present invention includes a first step of carrying out polymerization reaction by using at least an aromatic vinyl compound and a conjugated diene compound as monomers, to give a block copolymer including a polymer block (A) containing a structural unit derived from the aromatic vinyl compound and a polymer block (B) containing a structural unit derived from the conjugated diene compound.

In the aforementioned first step, the block copolymer can be produced, for example, according to a solution polymerization method, an emulsion polymerization method, or a solid phase polymerization method. Above all, a solution polymerization method is preferred, and for example, any known method, such as an ionic polymerization method, e.g., anionic polymerization and cationic polymerization, and a radical polymerization method is employable. Above all, an anionic polymerization method is preferred. In the anionic polymerization method, an aromatic vinyl compound and at least one selected from the group consisting of a conjugated diene compound and isobutylene are successively added in the presence of a solvent, an anionic polymerization initiator, and optionally a Lewis base, to give a block copolymer, and is optionally reacted with a coupling agent added thereto.

Examples of an organic lithium compound usable as a polymerization initiator for anionic polymerization include methyl lithium, ethyl lithium, n-butyl lithium, sec-butyl lithium, tert-butyl lithium, and pentyl lithium. In addition, examples of a dilithium compound usable as a polymerization initiator include naphthalene dilithium and dilithiohexylbenzene.

Examples of the coupling agent include dichloromethane, dibromomethane, dichloroethane, dibromoethane, dibromobenzene, and phenyl benzoate.

The use amount of these polymerization initiator and coupling agent can be appropriately determined depending upon the desired weight average molecular weight of the targeted block copolymer. Typically, the use amount of the initiator, such as an alkyl lithium compound and a dilithium compound, is preferably in a proportion of 0.01 to 0.2 parts by mass based on 100 parts by mass of the total of the monomers, such as the aromatic vinyl compound and the conjugated diene compound used for polymerization, and in the case where a coupling agent is used, it is preferably used in a proportion of 0.001 to 0.8 parts by mass based on 100 parts by mass of the total of the monomers.

The solvent is not particularly restricted so far as it does not adversely affect the anionic polymerization reaction, and examples thereof include aliphatic hydrocarbons, such as cyclohexane, methylcyclohexane, n-hexane, and n-pentane; and aromatic hydrocarbons, such as benzene, toluene, and xylene. In addition, the polymerization reaction is carried out at a temperature of typically 0 to 100° C., and preferably 10 to 70° C. for 0.5 to 50 hours, and preferably 1 to 30 hours.

By adding a Lewis base as a cocatalyst (vinylating agent) on the occasion of polymerization, the contents of the 3,4-bond and the 1,2-bond (vinyl bond amount) in the polymer block (B) can be increased.

Examples of the Lewis base include ethers, such as dimethyl ether, diethyl ether, tetrahydrofuran, and 2,2-di(tetrahydrofuryl)propane (DTHFP); glycol ethers, such as ethylene glycol dimethyl ether, diethylene glycol dimethyl ether, triethylene glycol dimethyl ether, and tetraethylene glycol dimethyl ether; amines, such as triethylamine, N,N,N′,N′-tetramethylenediamine, N,N,N′,N′-tetramethylethylenediamine (TMEDA), and N-methylmorpholine; and metal salts, such as sodium or potassium salts of an aliphatic alcohol, e.g., sodium t-butyrate, sodium t-amylate, and sodium isopentyrate, or a sodium dialkyl cyclohexanoate and sodium or potassium salts of an alicyclic alcohol, for example, sodium mentholate.

Of the aforementioned Lewis bases, tetrahydrofuran and DTHFP are preferably used from the viewpoint of vibration damping performance and heat stability. In addition, DTHEP is more preferably used because a high vinyl bond amount can be given, a high hydrogenation rate can be easily achieved without using an excessive amount of a hydrogenation catalyst, and both more excellent vibration damping performance and heat stability may be made compatible with each other.

These Lewis bases can be used alone or in combination of two or more thereof.

The addition amount of the Lewis base is determined how the vinyl bond amount of the conjugated diene unit constituting the polymer block (B) is controlled. Accordingly, though the addition amount of the Lewis base is not restricted in the strict sense, the Lewis base is used in a range of typically 0.1 to 1,000 mols, and preferably 1 to 100 mols per gram atom of lithium contained in the alkyl lithium compound or the dilithium compound used as the polymerization initiator.

In the aforementioned first step, after carrying out the polymerization, an active hydrogen compound, such as alcohols, carboxylic acids, and water, is added to terminate the polymerization reaction.

In the polymerization of the polymer block (B) of the first step, as for an average feed rate of the conjugated diene compound (hereinafter occasionally referred to as “average diene feed rate”), in the case of using plural kinds of conjugated diene compound as the polymer block (B), it is preferably 150 kg/h/mol or less, more preferably 100 kg/h/mol or less, still more preferably 70 kg/h/mol or less, and yet still more preferably 50 kg/h/mol or less from the viewpoint of securing the random properties in the polymer block (B). Although a lower limit of the average diene feed rate is not particularly restricted, for example, it is 0.1 kg/h/mol per mol of the active terminal from the viewpoint of productivity. In other words, in the polymerization of the polymer block (B) of the first step, the average feed rate of the conjugated diene compound is preferably 0.1 to 150 kg/h/mol.

In this specification, the “average diene feed rate” means a numerical value obtained by diving the mass of the whole of the conjugated diene compound by the time required for feeding the whole of the conjugated diene compound (diene feed time) and the molar number (mol) of the active terminal, and its unit is expressed by “kg/h/mol”. The molar number (mol) of the active terminal is a numerical value obtained by dividing the monomer amount (g) used for polymerization of the polymer block (A) by the weight average molecular weight of the polymer block (A).

### Production Method of Hydrogenated Block Copolymer

A production method of the hydrogenated block copolymer according to an embodiment of the present invention includes the aforementioned first step and a second step of hydrogenating the block copolymer.

In the second step, for example, hydrogenation is carried out in the presence of a hydrogenation catalyst in an inert organic solvent, to give hydrogenated copolymer.

The hydrogenation reaction can be carried out under a hydrogen pressure of 0.1 to 20 MPa, preferably 0.5 to 15 MPa, and more preferably 0.5 to 5 MPa at a reaction temperature of 20 to 250° C., preferably 50 to 180° C., and more preferably 70 to 180° C. for a reaction time of typically 0.1 to 100 hours, and preferably 1 to 50 hours.

From the viewpoint of carrying out the hydrogenation reaction of the polymer block (B) while retarding hydrogenation of aromatic ring of the aforementioned aromatic vinyl compound, examples of the hydrogenation catalyst include a Raney nickel; a Ziegler-based catalyst composed of a combination of a transition metal compound with an alkyl aluminum compound, an alkyl lithium compound, or the like; and a metallocene catalyst. From the same viewpoint as mentioned above, above all, a Ziegler-based catalyst is preferred, a Ziegler-based catalyst composed of a combination of a transition metal compound with an alkyl aluminum compound is more preferred, and a Ziegler-based catalyst composed of a combination of a nickel compound with an alkyl aluminum compound (Al/Ni-based Ziegler catalyst) is still more preferred.

In particular, as mentioned above, in the case of using DTHFP as the Lewis base in the first step, as the hydrogenated block copolymer obtained through the second step, one having a high Tg is easily given. Accordingly, a hydrogenated block copolymer having a high Tg, which is suited for the component (x), can be given.

The thus-obtained hydrogenated block copolymer can be acquired by pouring the polymerization reaction liquid into methanol or the like for precipitation therein, and filtrating after stirring, followed by heating or drying under reduced pressure, or by pouring the polymerization reaction liquid into hot water along with steam thereinto, thereby removing the solvent through azeotropy for so-called steam stripping, followed by heating or drying under reduced pressure.

### Production of Resin Composition

A production method of the aforementioned resin composition is not particularly restricted, and any known method is employable. For example, the hydrogenate (X) of the block copolymer that is the component (x) and the block copolymer (Y0) or its hydrogenate (Y), that is the component (y), are mixed using a mixing machine, such as a Henschel mixer, a V blender, a ribbon blender, a tumbler blender, and a conical blender, to produce a resin composition, or after mixing them, the resultant mixture is melt-kneaded using a single-screw extruder, a twin-screw extruder, a kneader, or the like, to produce a resin composition.

In the case where the resin composition includes the aforementioned additive in addition to the component (x) and the component (y), the aforementioned resin composition can be produced by mixing the additive together with the component (x) and the component (y) using the aforementioned mixing machine, or after mixing them, melt-kneading using the aforementioned apparatus.

### EXAMPLES

The present invention is hereunder described in more detail by Examples, but it should be construed that the present invention is by no means limited by these Examples.

### Measurement of Physical Properties of Hydrogenated Block Copolymer and Resin Composition

With respect to hydrogenated block copolymers TPE-1 to TPE-5 as mentioned later and respective resin compositions obtained in Examples and Comparative Examples as mentioned later, respective physical properties were measured according to the following measurement methods.

### Content of Polymer Block (A)

The hydrogenated block copolymer was dissolved in CDCl₃ and analyzed through the ¹H-NMR measurement [apparatus: “ADVANCE 400 Nano Bay” (available from Bruker Corporation), measurement temperature: 30° C.], and the content of the polymer block (A) was calculated from the peak intensity derived from styrene.

### Vinyl Bond Amount in Polymer Block (B)

The unhydrogenated block copolymer was dissolved in CDCl₃ and analyzed through the ¹H-NMR measurement [apparatus: “ADVANCE 400 Nano Bay” (available from Bruker Corporation), measurement temperature: 30° C.]. From the ratio of the peak area corresponding to the 3,4-bond unit and the 1,2-bond unit in the isoprene structural unit and the 1,2-bond unit in the butadiene structural unit relative to the total peak area of the structural units derived from isoprene and butadiene (TPE-1, TPE-4, and TPE-5), or the total peak area of the structural unit derived from isoprene (TPE-2 and TPE-3), the vinyl bond amount was calculated.

### Hydrogenation Rate of Polymer Block (B)

The hydrogenated block copolymer was dissolved in CDCl₃ and analyzed through the ¹-NMR measurement [apparatus: “ADVANCE 400 Nano Bay” (available from Bruker Corporation), measurement temperature: 30° C.]. From the ratio of the peak area derived from hydrogenated isoprene or hydrogenated butadiene to the peak area derived from the residual olefin of isoprene or butadiene, the hydrogenation rate was calculated.

### Weight Average Molecular Weight (Mw)

A weight average molecular weight (Mw) of the hydrogenated block copolymer as expressed in terms of polystyrene was determined through gel permeation chromatography (GPC) under the conditions mentioned below. In addition, with respect to the block copolymer (A) only before the addition of the conjugated diene compound, the Mw was measured by the same procedures.

### GPC Measurement Apparatus and Measurement Conditions

Apparatus: GPC apparatus “HLC-8020” (available from Tosoh Corporation)
Separation columns: Two columns of “TSKgel G4000HX” (available from Tosoh Corporation) were connected in series.

### Eluent: Tetrahydrofuran

Eluent flow rate: 0.7 mL/min
Sample concentration: 5 mg/10 mL
Column temperature: 40° C.
Detector: Differential refractive index (RI) detector
Calibration curve: Drawn using standard polystyrene

### Peak Top Temperature and Peak Top Intensity of tan δ of Hydrogenated Block Copolymer and Resin Composition

For the following measurement, each of the hydrogenated block copolymers obtained in Production Examples, and the resin compositions obtained in Examples and Comparative Examples was pressurized at a temperature of 230° C. under a pressure of 10 MPa for 3 minutes, to prepare a single-layered sheet having a thickness of 1.0 mm. The single-layered sheet was cut out in a disc shape, and this was designated as a test sheet.

For the measurement, a strain control dynamic viscoelastometer “ARES-G2” (available from TA Instruments Corporation) having a diameter of disc of 8 mm was used as parallel-plate oscillatory rheometer in conformity with JIS K7244-10(2005).

A gap between the two plates was completely filled by the test sheet, vibration was given to the sample at a strain of 1% and a frequency of 1 Hz in a share mode, and the temperature was increased from −80° C. to 100° C. at a constant rate of 3° C./min. Thereby determining a maximum value of the peak intensity of tan δ (peak top intensity) of the hydrogenated block copolymer and a temperature at which the foregoing maximum value was obtained (peak top temperature).

### Glass Transition Temperature (Tg)

Tg of each of the hydrogenated block copolymer and the mixture thereof was measured with DSC 250 (available from TA Instruments Corporation) by raising the temperature from −100° C. to 80° C. at a rate of 10° C./min, and a shift position of a baseline of the DSC curve (specifically, a point of intersection of the DSC curve and the line of an intermediate point of the baseline before and after of appearance of a specific heat change) was designated as “Tg”.

### Melt Flow Rate (MFR)

With respect to each of the hydrogenates of block copolymers obtained in Production Examples, and the resin compositions obtained in Examples and Comparative Examples, an outflow rate (g/10 min) of the sample was measured with a melt indexer under conditions of a temperature of 230° C. and a load of 2,160 g in conformity with JIS K7210:2014.

### Hardness

The resin composition obtained in each of Examples and Comparative Examples was injection-molded with an injection molding machine (“EC75SX”, available from Toshiba Machine Co., Ltd.) under conditions of a cylinder temperature of 200° C. and a the temperature of 40° C., to prepare a sheet having a size of 110 mm in length×110 mm in width×2 mm in thickness.

Three sheets of the obtained resin composition were piled up, and the hardness thereof was measured with an indenter of a type A durometer in conformity with JIS K6253-3:2012.

### Tensile Strength at Break and Tensile Elongation at Break

A sheet having a size of 110 mm in length×110 mm in width×2 mm in thickness as prepared in the same method as in the aforementioned (hardness) measurement was punched out into a form of a dumbbell No. 3 test piece, and the tensile strength at break and the tensile elongation at break were measured in the flow direction of each of MD and TD in conformity with JIS K6251:2010. It is meant that the higher the numerical value of each of the tensile strength at break and the tensile elongation at break, the more excellent of the tensile characteristics.

### Compression Set (70° C. and 100° C.)

The resin composition obtained in each of Examples and Comparative Examples was compression-molded at 200° C. for 3 minutes, to prepare a columnar test piece having a diameter of 13.0±0.5 mm and a thickness of 6.3±0.3 mm (d₀). This columnar test piece was subjected to 25% compression deformation using a spacer having a thickness of 4.8 mm (d₁) in conformity with JIS K 6262: 2013, and after holding under an atmosphere at 70° C. for 22 hours, the compression was released. Thereafter, the test piece was allowed to stand for 30 minutes under an atmosphere at 24° C. and a relative humidity of 50° C., and a thickness (d₂: mm) of the columnar test piece was measured, thereby determining the compression set (%) according to [100×(d₀−d₂)/(d₀−d₁)].

The compression set was measured in the same manner as mentioned above, except for changing the temperature at the time of compression to 100° C.

In any case, it is expressed that the lower the numerical value, the more excellent the resilience after prolonged compressive stresses.

### Production Example 1

### Production of Block Copolymer Hydrogenate TPE-1

50 kg of cyclohexane (solvent) dried with Molecular Sieves A4 and 0.087 kg of a cyclohexane solution of sec-butyl lithium having a concentration of 10.5% by mass as an anionic polymerization initiator (substantial addition amount of sec-butyl lithium: 9.1 g) were put into a pressure-resistant container which had been purged with nitrogen and dried.

The interior of the pressure-resistant container was subjected to temperature increase to 50° C., and 1.0 kg of styrene (1) was then added and polymerized for 30 minutes. After decreasing the temperature to 40° C., 63 g of 2,2-di(2-tetrahydrofuryl)propane (DTHFP) was added as a Lewis base, 8.16 kg of isoprene and 6.48 kg of butadiene were added over 6 hours (namely, the diene feed time was 6 hours, and the average diene feed rate was 17 kg/h/mol), and the contents were polymerized for 1 hour. Then, the temperature was increased to 50° C., and 1.0 kg of styrene (2) was added and polymerized for 30 minutes. Then, methanol was put thereinto to terminate the reaction, to obtain a reaction liquid including a polystyrene-poly(isoprene/butadiene)-polystyrene triblock copolymer.

To the reaction liquid, a Ziegler-based hydrogenation catalyst formed of nickel octylate and trimethylaluminum was added under a hydrogen atmosphere and reacted under conditions of a hydrogen pressure of 1 MPa at 80° C. for 5 hours. After allowing the reaction liquid to cool and releasing the pressure, the catalyst was removed by washing with water, and the residue was vacuum-dried to obtain a polystyrene-poly(isoprene/butadiene)-polystyrene triblock copolymer hydrogenate (TPE-1).

### Production Examples 2 to 5

### Production of Block Copolymer Hydrogenates TPE-2 to TPE-5

Hydrogenated block copolymers TPE-2, TPE-3, TPE-4, and TPE-5 were produced by the same procedures as in Production Example 1, except for changing the raw materials and use amounts thereof to those shown in Table 1.

TABLE 1

| | | | Production Example | | | | |
|---|---|---|---|---|---|---|---|
| | | | 1 | 2 | 3 | 4 | 5 |
| | | | Component (x) | | Component (y) | | |
| Block copolymer hydrogenate | | | TPE-1 | TPE-2 | TPE-3 | TPE-4 | TPE-5 |
| Use amount | Cyclohexane | | 50 | 50 | 50 | 50 | 50 |
| (kg) | sec-Butyl lithium (10.5% by mass | | 0.087 | 0.087 | 0.101 | 0.046 | 0.065 |
| | cyclohexane solution) | | | | | | |
| | Polymer | Styrene (1) | 1.0 | 1.0 | 1.7 | 1.9 | 0.8 |
| | block (A) | Styrene (2) | 1.0 | 1.0 | 1.7 | 1.9 | 0.8 |
| | Polymer | Isoprene | 8.16 | 14.6 | 13.3 | 4.9 | 6.1 |
| | block (B) | Butadiene | 6.48 | 0 | 0 | 3.9 | 4.9 |
| | Lewis base | Tetrahydrofuran | 0 | 0 | 0.29 | 0 | 0.30 |
| | | DTHFP | 0.063 | 0.032 | 0 | 0 | 0 |

The measurement results of each of the hydrogenated block copolymers are shown in Table 2 together with the composition thereof.

TABLE 2

| | Production Example | | | | |
|---|---|---|---|---|---|
| | 1 | 2 | 3 | 4 | 5 |
| | Component (x) | | Component (y) | | |
| Block copolymer hydrogenate used | TPE-1 | TPE-2 | TPE-3 | TPE-4 | TPE-5 |
| Structural unit of polymer block (A) | St | St | St | St | St |
| Components constituting polymer block (B) | Ip/Bd | Ip | Ip | Ip/Bd | Ip/Bd |
| Mass ratio of components constituting polymer | 55/45 | 100 | 100 | 55/45 | 55/45 |
| block (B) | | | | | |
| Molar ratio of components constituting polymer | 50/50 | 100 | 100 | 50/50 | 50/50 |
| block (B) | | | | | |
| Polymer structure | A/B/A | A/B/A | A/B/A | A/B/A | A/B/A |
| Content of polymer block (A) (% by mass) | 12 | 12 | 20 | 30 | 12 |
| Weight average molecular weight of block | 170,000 | 150,000 | 130,000 | 300,000 | 170,000 |
| copolymer hydrogenate | | | | | |
| Hydrogenation rate of polymer block (B) (mol %) | 95 | 88 | 90 | 99 | 99 |
| Vinyl bond amount of polymer block (B) (mol %) | 76 | 83 | 60 | 7 | 60 |
| MFR at 230° C. and 2.16 kg (g/10 min) | 1 | 15 | 4 | No flow | 2.2 |
| Glass transition temperature (° C.) | 4 | 20 | −15 | −55 | −31 |
| Peak top temperature of tan δ (° C.) | 15 | 32 | −7 | −48 | −20 |
| Peak top intensity of tan δ | 2.2 | 2.2 | 2.2 | 0.1 | 2.0 |

As shown in Table 2, in all of the hydrogenated block copolymers TPE-1 and TPE-2, the Tg is −10° C. or higher, and the aforementioned requirement [1] is satisfied. In addition, in all of the hydrogenated block copolymers TPE-3 to TPE-5, the Tg is lower than −10° C., the aforementioned requirement [2] is satisfied.

### Example 1

Using a twin-screw extruder (“ZSK26Mc”, available from Coperion Corporation), 33 parts by mass of the hydrogenated block copolymer TPE-2, 33 parts by mass of the hydrogenated block copolymer TPE-4, 14 parts by polypropylene, and 20 parts by mass of a paraffin oil were melt-kneaded under conditions of a cylinder temperature of 230° C. and a screw revolution number of 300 rpm, to produce a resin composition.

As the polypropylene, “FH P4G2Z-026”, available from Flint Hills Resources, LLC was used. In addition, as the paraffin oil, “Krystol 550”, available from Petro-Canada Lubricants, Inc. was used.

### Examples 2 and 3 and Comparative Examples 1 and 2

Resin compositions were produced by the same procedures as in Example 1, except for changing the raw materials to be used and use amounts thereof to those shown in Table 3.

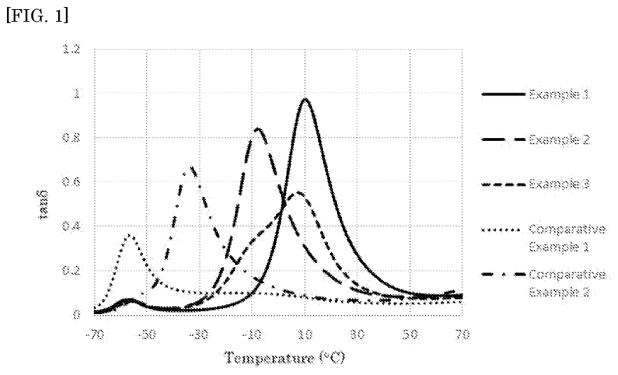

The measurement results of various physical properties of each of the resin compositions obtained in Examples 1 to 3 and Comparative Examples 1 to 2 are shown in Table 3 together with the composition thereof of each of the resin compositions. In addition, FIG. 1 is a graph expressing temperature characteristics of tan δ of the resin compositions obtained in Examples 1 to 3 and Comparative Examples 1 to 2.

TABLE 3

| | | | Example | | | Comparative Example | |
|---|---|---|---|---|---|---|---|
| | | Unit | 1 | 2 | 3 | 1 | 2 |
| Component (x) | TPE-1 | Parts by mass | — | 33 | 16.5 | — | — |
| | TPE-2 | Parts by mass | 33 | — | 16.5 | — | — |
| Component (y) | TPE-4 | Parts by mass | 33 | 33 | 33 | 42 | 33 |
| | TPE-5 | Parts by mass | — | — | — | — | 33 |
| Component (z1) | PP | Parts by mass | 14 | 14 | 14 | 16 | 14 |
| Component (z2) | Paraffin oil | Parts by mass | 20 | 20 | 20 | 42 | 20 |

| | | | | | | |
|---|---|---|---|---|---|---|
| Tg of component (x) | ° C. | 20 | 4 | 12 | — | — |
| Tg of component (y) | ° C. | −55 | −55 | −55 | −55 | −43 |
| Hardness (Type A) | — | 64 | 63 | 66 | 65 | 61 |
| MFR (at 230° C. and 2.16 kg) | g/10 min | 8 | 1 | 2.3 | 0.1 | 1.1 |
| Peak top intensity of tan δ | — | 1 | 0.8 | 0.5 | 0.4 | 0.7 |
| Peak top temperature of tan δ | ° C. | 10 | −8 | 7 | −57 | −33 |
| Temperature range where tan δ ≥ 0.15 | ° C. | 46 | 45 | 48 | 0 | 40 |
| Full width at half maximum of tan δ | ° C. | 22 | 22 | 33 | 18 | 18 |
| Tensile strength at break (MD) | MPa | 11 | 11 | 11 | 4 | 8 |
| Tensile elongation at break (MD) | % | 650 | 700 | 650 | 470 | 690 |
| Tensile strength at break (TD) | MPa | 10 | 18 | 17 | 15 | 11 |
| Tensile elongation at break (TD) | % | 690 | 820 | 810 | 740 | 780 |
| Compression set (at 70° C.) | % | 80 | 53 | 59 | 39 | 57 |
| Compression test (at 100° C.) | % | 85 | 65 | 68 | 61 | 68 |

As shown in Table 3, the resin compositions of Examples 1 to 3 include at least one of TPE-1 and TPE-2 that are the block copolymer hydrogenate corresponding to the component (x) and TPE-4 that is the block copolymer hydrogenate corresponding to the component (y) and satisfy the requirements [1] to [3]. Then, as is evident from Table 3 and FIG. 1, the resin compositions of Examples 1 to 3 have a peak of tan δ at −8° C. to +10° C., have a temperature range where the value of tan δ becomes 0.15 or higher of 45 to 48° C., and exhibit a high tan δ intensity in a broad temperature range including room temperature. In addition, as is evident from Table 3, in the resin compositions of Examples 1 to 3, the values of the temperature strength at break (MD) and the tensile elongation at break (MD) are large, so that it is noted that the resin compositions of Examples 1 to 3 are excellent in the tensile strength. In addition thereto, the resin compositions of Examples 2 and 3 are large in the tensile strength at break (TD) and the tensile elongation at break (TD) and small in the value of the compression set as compared with the resin composition of Example 1. Namely, it is noted that the resin compositions of Examples 2 and 3 are excellent in the molding processability and the rubber elasticity at a high temperature.

In particular, the resin composition of Example 3 including two kinds of the component (x) is large in the full width at half maximum of tan δ and large in the temperature range where the value of tan δ becomes 0.15 or higher as compared with the resin compositions of Examples 1 and 2 including one kind of the component (x).

In the light of the above, it is noted that the resin compositions of Examples 1 to 3 are provided with both high vibration damping performance in the vicinity of room temperature and flexibility in a low temperature range.

On the other hand, the resin composition of Comparative Example 1 is the hydrogenate (X) of the block copolymer having the polymer block (A-1) derived from the aromatic vinyl compound and the polymer block (B-1) derived from the conjugated diene compound and does not include the component having a glass transition temperature of −10° C. or higher. Namely, the resin composition of Comparative Example 1 does not satisfy the aforementioned requirements [1] and [3]. Then, as is evident from Table 3 and FIG. 1, in the resin composition of Comparative Example 1, the peak top temperature of tan δ is low, and the temperature range where the value of tan δ becomes 0.15 or higher does not exist. In addition, the resin composition of Comparative Example 1 is small in the full width at half maximum of tan δ and small in the tensile strength at break (MD) and the tensile elongation at break (MD) as compared with the resin compositions of Examples 1 to 3. In addition, though the resin composition of Comparative Example 2 includes two kinds of the block copolymer hydrogenate, it is the hydrogenate (X) of the block copolymer having the polymer block (A-1) including the structural unit derived from the aromatic vinyl compound and the polymer block (B-1) including the structural unit derived from the conjugated diene compound and does not include the component having a glass transition temperature of −10° C. or higher. Namely, the resin composition of Comparative Example 2 does not satisfy the aforementioned requirements [1] and [3]. Furthermore, as is evident from Table 3 and FIG. 1, in the resin composition of Comparative Example 2, the peak top temperature of tan δ is low. In addition thereto, the resin composition of Comparative Example 2 is small in the full width at half maximum of tan δ and small in the tensile strength at break (MD) and the tensile elongation at break (MD) as compared with the resin compositions of Examples 1 to 3.

In consequence, it is noted that the resin compositions of Comparative Examples 1 and 2 are inferior in the vibration damping performance in the vicinity of room temperature and the tensile strength to the resin compositions of Examples 1 to 3.

### Example 4 and Comparative Example 3

Resin compositions were produced by the same procedures as in Example 1, except for changing the raw materials to be used and use amounts thereof to those shown in Table 4.

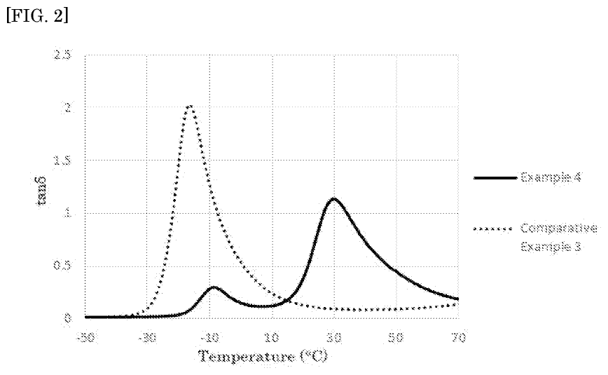

The measurement results of various physical properties of each of the resin compositions obtained in Example 4 and Comparative Example 3 are shown in Table 4 together with the composition thereof of each of the resin compositions. In addition, FIG. 2 is a graph expressing temperature characteristics of tan δ of the resin compositions obtained in Example 4 and Comparative Example 3.

TABLE 4

| | | | | Comparative |
|---|---|---|---|---|
| | | | Example | Example |
| | | Unit | 4 | 3 |
| Component (x) | TPE-2 | Parts by mass | 50 | — |
| Component (y) | TPE-3 | Parts by mass | 50 | 25 |
| | TPE-5 | Parts by mass | — | 75 |

| | | | |
|---|---|---|---|
| Tg of component (x) | ° C. | 4 | — |
| Tg of component (y) | ° C. | −15 | −26 |
| Peak top intensity of tan δ | — | 1.1 | 2.0 |
| Peak top temperature of tan δ | ° C. | 31 | −16 |
| Temperature range where tan | ° C. | 50 | 42 |
| δ ≥ 0.15 | | | |
| Full width at half maximum | ° C. | 27 | 13 |
| of tan δ | | | |

As shown in Table 4, the resin composition of Example 4 includes TPE-2 that is the block copolymer hydrogenate corresponding to the component (x) and TPE-3 that is the block copolymer hydrogenate corresponding to the component (y) and satisfy the requirements [1] to [3]. Then, as is evident from Table 4 and FIG. 2, the resin composition of Example 4 has a peak of tan δ at a temperature close to room temperature and exhibits a high tan δ intensity in a broad temperature range including room temperature. In consequence, it is noted that the resin composition of Example 4 may reveal low resilience in a broad temperature range including room temperature.

On the other hand, the resin composition of Comparative Example 3 is the hydrogenate (X) of the block copolymer having the polymer block (A-1) derived from the aromatic vinyl compound and the polymer block (B-1) derived from the conjugated diene compound and does not include the component having a glass transition temperature of −10° C. or higher. Namely, the resin composition of Comparative Example 3 does not satisfy the aforementioned requirements [1] and [3]. Then, as is evident from Table 4 and FIG. 2, in the resin composition of Comparative Example 3, the peak temperature of tan δ is −16° C., and the peak temperature of tan δ is low, the temperature range where the tan δ becomes 0.15 or more is narrow, and the full width at half maximum of tan δ is small as compared with the resin composition of Example 4. In consequence, it can be understood that the resin composition of Comparative Example 3 is inferior to the resin composition of Example 4 in terms of wideness of the favorable temperature range of low resilience.

### INDUSTRIAL APPLICABILITY

The resin composition of the present invention can be used for members for shoe soles, such as an inner sole, a sock liner, a midsole, and an outer sole; automobile casing; various components to be mounted in a car and housing thereof; and so on. In addition, the resin composition of the present invention can also be used for various electric products in a field of household appliances, such as televisions, various recorders such as a Blu-ray recorder and a HDD recorder, as well as projectors, game machines, digital cameras, home videos, antennas, speakers, electronic dictionaries, IC recorders, FAX machines, copying machines, telephones, door phones, rice cookers, microwave ovens, ovens, refrigerators, dishwashers, dish driers, IH cooking heaters, hot plates, vacuum cleaners, washing machines, rechargers, sewing machines, clothes irons, driers, electric vehicles, air cleaners, water cleaners, electric toothbrushes, lighting equipment, air conditioners, air conditioner outdoor units, dehumidifiers, and humidifiers.

1. A resin composition comprising
a component (x) that is a hydrogenate (X) of a block copolymer having a polymer block (A-1) containing a structural unit derived from an aromatic vinyl compound and a polymer block (B-1) containing a structural unit derived from a conjugated diene compound; and
a component (y) that is a block copolymer (Y0) having a polymer block (A-2) containing a structural unit derived from an aromatic vinyl compound and a polymer block (B-2) containing a structural unit derived from a conjugated diene compound, or a hydrogenate (Y) thereof, wherein
the resin composition satisfies the following requirements [1] to [3];
[1] a glass transition temperature of the component (x) is −10° C. or higher;
[2] a glass transition temperature of the component (y) is lower than −10° C.; and
[3] a ratio Mx/My of a mass Mx of the component (x) to a mass My of the component (y) in the resin composition is 1/99 to 99/1.

2. The resin composition according to claim 1, wherein the content of the polymer block (A-1) in the component (x) is 18% by mass or less.

3. The resin composition according to claim 1, wherein a hydrogenation rate of the component (x) is 85 mol % or more.

4. The resin composition according to claim 1, wherein a weight average molecular weight of the component (x) is 100,000 to 250,000.

5. The resin composition according to claim 1, wherein a melt flow rate of the component (x) as measured under a load of 2,160 g at 230° C. in conformity with JIS K7210:2014 is 30 g/10 min or less.

6. The resin composition according to claim 1, wherein the polymer block (B-1) includes a structural unit derived from isoprene.

7. The resin composition according to claim 1, wherein the content of a structural unit derived from styrene of the polymer block (B-1) is 5% by mass or less.

8. The resin composition according to claim 1, wherein a vinyl bond amount of the polymer block (B-1) is 65 mol % or more.

9. The resin composition according to claim 1, wherein the content of the polymer block (A-2) in the component (y) is 35% by mass or less.

10. The resin composition according to claim 1, wherein the component (y) is the hydrogenate (Y) of the block copolymer, and a hydrogenation rate of the hydrogenate (Y) of the block copolymer is 85 mol % or more.

11. The resin composition according to claim 1, wherein a weight average molecular weight of the component (y) is 40,000 to 500,000.

12. The resin composition according to claim 1, wherein the polymer block (B-2) includes a structural unit derived from isoprene.

13. The resin composition according to claim 1, wherein the glass transition temperature of the component (y) is lower than −40° C.

14. The resin composition according to claim 1, wherein the glass transition temperature of the component (y) is −40° C. or higher.

15. The resin composition according to claim 1, wherein the Mx/My is 30/70 to 95/5.

16. The resin composition according to claim 1, wherein the component (x) includes two kinds of the hydrogenate (X) of the block copolymer.

17. The resin composition according to claim 1, wherein
polypropylene is further included as a component (z1); and
a paraffin oil is further included as a component (z2).

18. The resin composition according to claim 1, wherein a full width at half maximum of the resin composition relative to a peak intensity of tan δ as measured under conditions of a strain amount of 0.1%, a frequency of 1 Hz, a measurement temperature of −70 to +50° C., and a rate of temperature increase of 3° C./min in conformity with JIS K7244-10 (2005) is 20° C. or more.

19. The resin composition according to claim 1, wherein a serial temperature range where a tan δ of the resin composition as measured under conditions of a strain amount of 0.1%, a frequency of 1 Hz, a measurement temperature of −30 to +50° C., and a rate of temperature increase of 3° C./min in conformity with JIS K7244-10 (2005) becomes 0.15 or more is existent, and a total width of the temperature range is 30° C. or more.
